(19) United States
(12) Patent Application Publication
(10) Pub. No.: US 2009/0240474 A1
(43) Pub. Date: Sep. 24, 2009

(54) SYSTEM AND METHOD FOR GENERATING A MODEL OF AN IMAGE MEASURING MACHINE

(75) Inventors: CHIH-KUANG CHANG, Tu-Cheng (TW); LI JIANG, Shenzhen City (CN); YI-RONG HONG, Shenzhen City (CN); JUN GUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HON HAI PRECISION INDUSTRY CO., LTD., Tu-Cheng (TW); HONG FU JIN PRECISION INDUSTRY(ShenZhen) CO., LTD., Shenzhen City (TW)

(21) Appl. No.: 12/253,932

(22) Filed: Oct. 17, 2008

(30) Foreign Application Priority Data
Mar. 21, 2008 (CN) 200810300666.3

(51) Int. Cl. G06F 17/50

(52) U.S. Cl. 703/1

(57) ABSTRACT

A method for generating a model of an image measuring machine is disclosed. The method includes obtaining vertex coordinates of the image measuring machine and features that need to be generated from a configuration file stored in a storage device of a computer. The features comprise a top cover, a lens, a workplace, and a holder of the image measuring machine. The vertex coordinates comprise the vertex coordinates of the top cover, the lens, the workplace, and the holder. The method further includes generating the features of the top cover, the lens, the workplace, and the holder using graphical interfaces according to the corresponding vertex coordinates, so as to create the model of the image measuring machine, and displaying the model of the image measuring machine on a display device.

### BACKGROUND

1. Field of the Invention

Embodiments of the present disclosure relate to systems and methods for measuring images, and particularly to a system and method for generating a model of an image measuring machine.

2. Description of Related Art

Measurement is an important phase in the manufacturing process and is closely interrelated to the product quality of an object. Generally, an engineer will use an image measuring machine to obtain an electronic image of an object. The image is stored in a computer and may be shown on a display device, where a program is used to determine precision of the object according to data of pixel points in the image.

However, in the traditional method, the electronic image only includes a model of the object, a model of the image measuring machine is not shown in the electronic image. It is inconvenience for the user to observe a position of the object relative to the image measuring machine.

What is needed, therefore, is a system and method for generating a model of an image measuring machine.

### SUMMARY

A computer-implemented method for generating a model of an image measuring machine is provided. The method includes: reading a configuration file from a storage device of a computer, wherein the configuration file stores all vertex coordinates of the image measuring machine and features that need to be generated, the features comprising a top cover, a lens, a workplace, and a holder of the image measuring machine; obtaining the vertex coordinates of the image measuring machine, wherein the vertex coordinates comprise vertex coordinates of the top cover, the lens, the workplace, and the holder; generating the features of the top cover, the lens, the workplace, and the holder using graphical interfaces according to the corresponding vertex coordinates, so as to create the model of the image measuring machine; displaying the model of the image measuring machine on a display device.

Other systems, methods, features, and advantages of the present disclosure will become apparent to one with ordinary skill in the art upon examination of the following drawings and detailed description.

### BRIEF DESCRIPTION OF THE DRAWINGS

FIG. 1 is a block diagram of one embodiment of a system for generating a model of an image measuring machine;

FIG. 2 is a block diagram of one embodiment of an interface module shown in FIG. 1;

FIG. 3 is a flowchart of one embodiment of a method for generating a model of an image measuring machine;

FIG. 4 is a detailed description for generating features of a top cover of an image measuring machine; and

FIG. 5 is a schematic diagram of a model of an image measuring machine.

### DETAILED DESCRIPTION OF CERTAIN INVENTIVE EMBODIMENTS

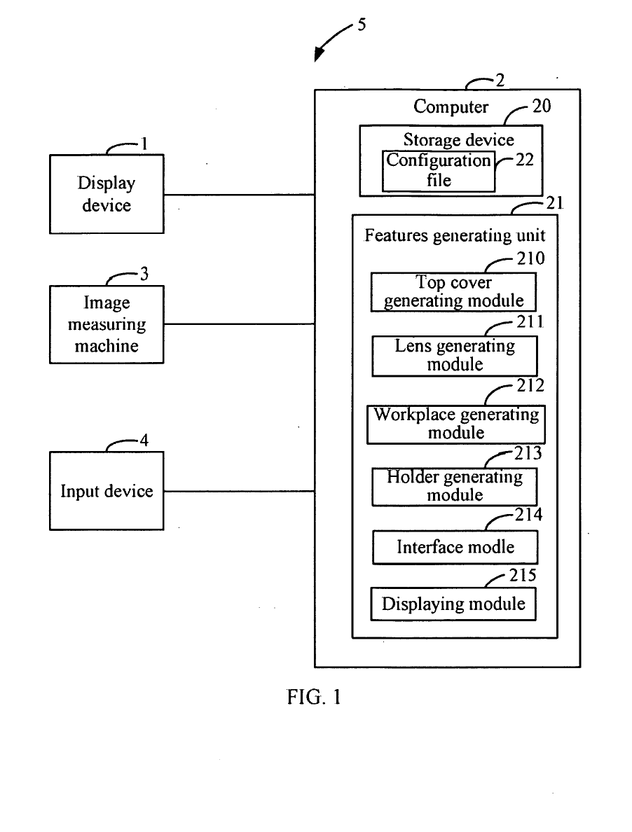

FIG. 1 is a block diagram of one embodiment of a system 5 for generating a model of an image measuring machine. In one embodiment, the system 5 includes a display device 1, a computer 2, an image measuring machine 3, and an input device 4. The display device 1, the image measuring machine 3, and the input device 4 are electronically connected to the computer 2.

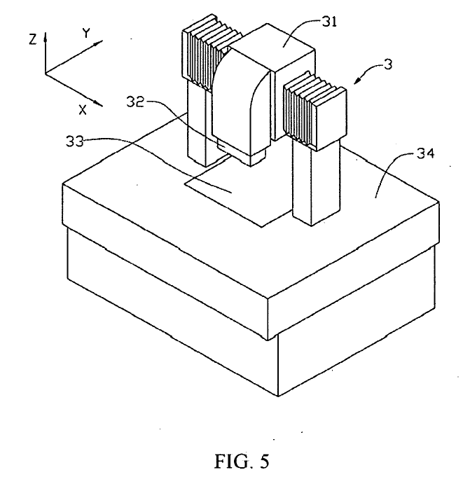

A schematic diagram of the model of the image measuring machine 3 is shown in FIG. 5. In one embodiment, the model of the image measuring machine 3 includes a top cover 31, a lens 32, a workplace 33, and a holder 34.

The computer 2 includes a storage device 20 and a features generating unit 21. A configuration file 22 stored in the storage device 20 stores all vertex coordinates of the image measuring machine 3 and features that need to be generated in a Digital Audio Tape (DAT) file, for example. The features comprise the top cover 31, the lens 32, the workplace 33, and the holder 34 of the image measuring machine 3. In one embodiment, the features of the top cover may include lines, planes, circles, ellipses, B-spline curves, B-spline surfaces, and rotatable objects.

The image measuring machine 3 captures an image of an object, and sends the image to the computer 2. The features generating unit 21 is configured for automatically generating the features according to the vertex coordinates stored in the configuration file 22, so as to create the model of the image measuring machine 3, and display the model of the image measuring machine 3 along with the image of the object on the display device 1.

The input device 4 is provided for manually altering the model of the image measuring machine 3 displayed on the display device 1, e.g., parallel moving the model, rotating the model, zooming in or zooming out the model.

The features generating unit 21 may include a top cover generating module 210, a lens generating module 211, a workplace generating module 212, a holder generating module 213, an interface module 214, and a displaying module 215. The modules 210, 211, 212, 213, 214, and 215 may be used to execute one or more operations of the features generating unit 21.

The features generating unit 21 is configured for reading the configuration file 22 from the storage device 20. As mentioned above, the configuration file 22 stores all vertex coordinates of the image measuring machine 3 and the features that need to be generated. Then, the features generating unit 21 obtains the vertex coordinates of the image measuring machine 3. The vertex coordinates comprise vertex coordinates of the top cover 31, the lens 32, the workplace 33, and the holder 34.

The top cover generating module 210 is configured for generating the features of the top cover 31 using graphical interfaces according to the vertex coordinates of the top cover 31.

The lens generating module 211 is configured for generating the features of the lens 32 using graphical interfaces according to the vertex coordinates of the lens 32.

The workplace generating module 212 is configured for generating the features of the workplace 33 using graphical interfaces according to the vertex coordinates of the workplace 33.

The holder generating module 213 is configured for generating the features of the holder 34 using graphical interfaces according to the vertex coordinates of the holder 34.

The displaying module 215 is configured for displaying all the features to show the model of the image measuring machine 3 on the display device 1.

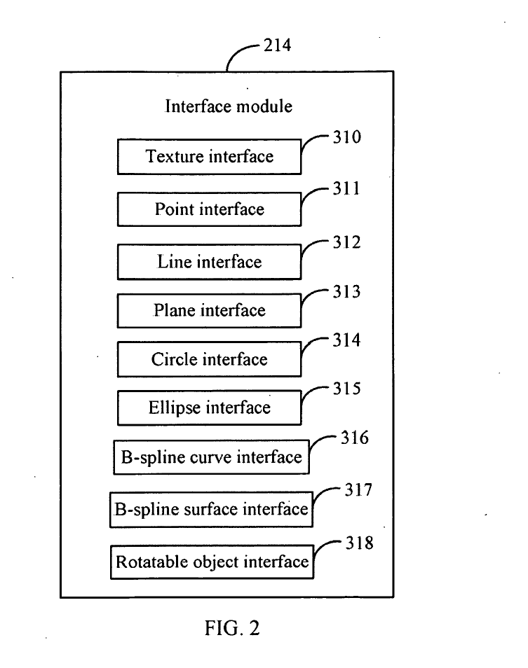

The interface module 214 is configured for providing the graphical interfaces for the module 210, 211, 212, and 213. The graphical interfaces are graphical functions for generating different features in an image processing software (e.g., Open Graphics Library, OpenGL). A block diagram of one embodiment of the interface module 214 is shown in FIG. 2. In one embodiment, the interface module 214 includes a texture interface 310 for loading texture, a point interface 311 for generating point features, a line interface 312 for generating line features, a plane interface 313 for generating plane features, a circle interface 314 for generating circle features, an ellipse interface 315 for generating ellipse features, a B-spline curve interface 316 for generating B-spline features, a B-spline surface interface 317 for generating B-spline surfaces, and a rotatable object interface 318 for generating rotatable object features.

The features generating unit 21 is further configured for regenerating the features according to new vertex coordinates of the image measuring machine 3 if the model is moved. In one embodiment, the move is selected from the group consisting of a parallel move, a rotatable move, a zoom in move and a zoom out move.

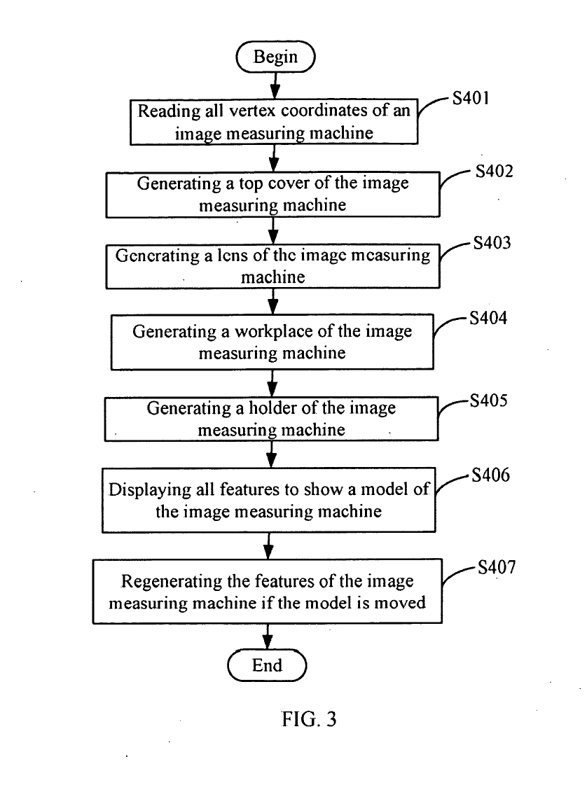

FIG. 3 is a flowchart of one embodiment of a method for generating a model of an image measuring machine. Depending on the embodiment, additional blocks may be added, others removed, and the ordering of the blocks may be changed.

In block S401, the features generating unit 21 reads the configuration file 22 from the storage device 20. The configuration file 22 stores all vertex coordinates of the image measuring machine 3 and features that need to be generated. In one embodiment, the features comprises the top cover 31, the lens 32, the workplace 33, and the holder 34 of the image measuring machine 3. Then, the features generating unit 21 obtains the vertex coordinates of the image measuring machine 3. The vertex coordinates comprise vertex coordinates of the top cover 31, the lens 32, the workplace 33, and the holder 34.

In block S402, the top cover generating module 210 generates the features of the top cover 31 using graphical interfaces according to the vertex coordinates of the top cover 31.

In block S403, the lens generating module 211 generates the features of the lens 32 using graphical interfaces according to the vertex coordinates of the lens 32.

In block S404, the workplace generating module 212 generates the features of the workplace 33 using graphical interfaces according to the vertex coordinates of the workplace 33.

In block S405, the holder generating module 213 generates the features of the holder 34 using graphical interfaces according to the vertex coordinates of the holder 34.

In block S406, the displaying module 215 displays all the features to show the model of the image measuring machine 3 on the display device 1.

In block S407, the features generating unit 21 regenerates the features according to new vertex coordinates of the image measuring machine 3 if the model is moved. In one embodiment, the move is selected from the group consisting of a parallel move, a rotatable move, a zoom in move and a zoom out move.

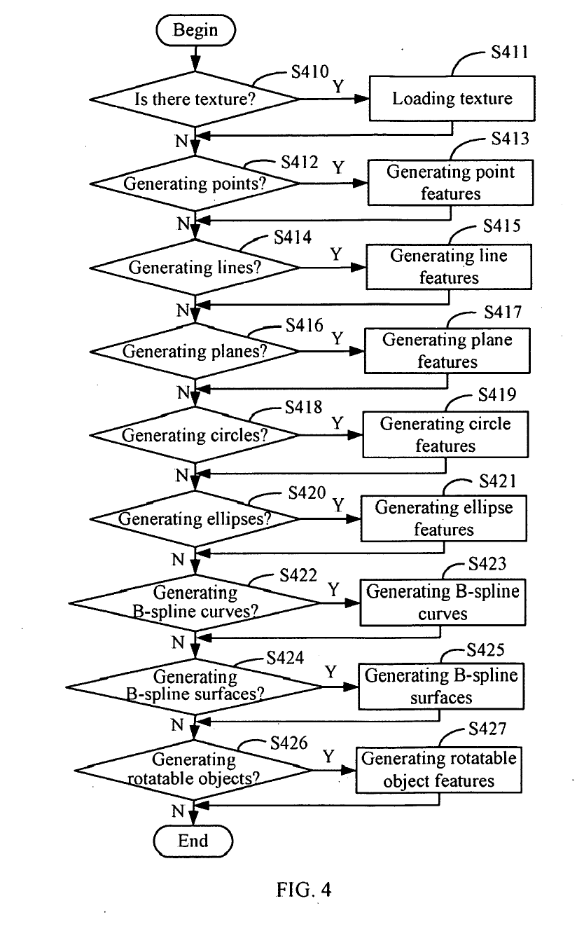

FIG. 4 is a detailed description of block S402 for generating the features of the top cover of an image measuring machine. Depending on the embodiment, additional blocks may be added, others removed, and the ordering of the blocks may be changed.

In block S410, the top cover generating module 210 determines if there is texture on the top cover 31 according to the configuration file 22. If there is texture on the top cover 31, in block S411, the top cover generating module 210 loads texture using the texture interface 310. If there is not texture on the top cover 31, the procedure goes to block S412.

In block S412, the top cover generating module 210 determines if points need to be generated for the top cover 31 according to the configuration file 22. If points need to be generated, in block S413, the top cover generating module 210 generates point features using the point interface 311. If points need not to be generated, the procedure goes to block S414.

In block S414, the top cover generating module 210 determines if lines need to be generated for the top cover 31 according to the configuration file 22. If lines need to be generated, in block S415, the top cover generating module 210 generates line features using the line interface 312. If lines need not to be generated, the procedure goes to block S416.

In block S416, the top cover generating module 210 determines if planes need to be generated for the top cover 31 according to the configuration file 22. If planes need to be generated, in block S417, the top cover generating module 210 generated plane features using the plane interface 313. If planes need not to be generated, the procedure goes to block S418.

In block S418, the top cover generating module 210 determines if circles need to be generated on the top cover 31 according to the configuration file 22. If circles need to be generated, in block S419, the top cover generating module 210 generates circle features using the circle interface 314. If circles need not to be generated, the procedure goes to block S420.

In block S420, the top cover generating module 210 determines if ellipses need to be generated for the top cover 31 according to the configuration file 22. If ellipses need to be generated, in block S421, the top cover generating module 210 generates ellipse features using the ellipse interface 315. If ellipses need not to be generated, the procedure goes to block S422.

In block S422, the top cover generating module 210 determines if B-spline curves need to be generated for the top cover 31 according to the configuration file 22. If B-spline curves need to be generated, performing block S423, the top cover generating module 210 generates B-spline curves using the B-spline curve interface 316. If B-spline curves need not to be generated, the procedure goes to block S424.

In block S424, the top cover generating module 210 determines if B-spline surfaces need to be generated for the top cover 31 according to the configuration file 22. If B-spline surfaces need to be generated, in block S425, the top cover generating module 210 generates B-spline surfaces using the B-spline surface interface 317. If B-spline surfaces need not to be generated, the procedure goes to block S426.

In block S426, the top cover generating module 210 determines if rotatable objects need to be generated for the top cover 31 according to the configuration file 22. If rotatable objects need to be generated, in block S427, the top cover generating module 210 generates rotatable object features using the rotatable object interface 318. If rotatable objects need not to be generated, the procedure ends.

In one embodiment, the detailed descriptions of block S403, block S404, block S405 are similar to the detailed description of block S402 in FIG. 4 as described above.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for generating a model of an image measuring machine, the method comprising:
reading a configuration file from a storage device of a computer, wherein the configuration file stores all vertex coordinates of the image measuring machine and features that need to be generated, the features comprising a top cover, a lens, a workplace, and a holder of the image measuring machine;
obtaining the vertex coordinates of the image measuring machine, wherein the vertex coordinates comprise vertex coordinates of the top cover, the lens, the workplace, and the holder;
generating the features of the top cover, the lens, the workplace, and the holder using graphical interfaces according to the corresponding vertex coordinates, so as to create the model of the image measuring machine; and
displaying the model of the image measuring machine on a display device.

2. The method according to claim 1, further comprising: regenerating the features according to new vertex coordinates of the image measuring machine if the model is moved.

3. The method according to claim 2, wherein the move is selected from the group consisting of a parallel move, a rotatable move, a zoom in move and a zoom out move.

4. The method according to claim 1, wherein the graphical interfaces are graphical functions for generating different features.

5. The method according to claim 1, wherein the graphical interfaces comprise a texture interface for loading texture, a point interface for generating point features, a line interface for generating line features, a plane interface for generating plane features, a circle interface for generating circle features, an ellipse interface for generating ellipse features, a B-spline curve interface for generating B-spline curves, a B-spline surface interface for generating B-spline surfaces, and a rotatable object interface for generating rotatable object features.

6. A computer-readable medium having stored thereon instructions that, when executed by a computer, causing the computer to:
read a configuration file from a storage device of a computer, wherein the configuration file stores all vertex coordinates of an image measuring machine and features that need to be generated, the features comprising a top cover, a lens, a workplace, and a holder of the image measuring machine;
obtaining the vertex coordinates of the image measuring machine, wherein the vertex coordinates comprise vertex coordinates of the top cover, the lens, the workplace, and the holder;
generating the features of the top cover, the lens, the workplace, and the holder using graphical interfaces according to the corresponding vertex coordinates, so as to create a model of the image measuring machine; and
displaying the model of the image measuring machine on a display device.

7. The method according to claim 6, wherein computer-readable medium is selected from the group consisting of a hard disk drive, a compact disc, a digital video disc, and a tape drive.

8. A computing system for generating a model of an image measuring machine, comprising:
a configuration file stored in a storage device of a computer, wherein the configuration file stores all vertex coordinates of the image measuring machine and features that need to be generated, the features comprising a top cover, a lens, a workplace, and a holder of the image measuring machine;
a features generating unit configured for generating the features of the top cover, the lens, the workplace, and the holder using graphical interfaces according to the corresponding vertex coordinates, so as to create the model of the image measuring machine; and
the features generating unit further configured for displaying the model of the image measuring machine on a display device.

9. The system according to claim 8, wherein the features generating unit is further configured for regenerating the features according to new vertex coordinates of the image measuring machine if the model is moved.

10. The system according to claim 9, wherein the move is selected from the group consisting of a parallel move, a rotatable move, a zoom in move and a zoom out move.
